(19) United States
(12) Patent Application Publication
(10) Pub. No.: US 2008/0188247 A1
(43) Pub. Date: Aug. 7, 2008

(54) Hierarchical organization of paging groups

(75) Inventor: Chandrika K. Worrall, Newbury (GB)

Correspondence Address: MORRISON & FOERSTER LLP, 425 MARKET STREET, SAN FRANCISCO, CA, 94105-2482, US

(73) Assignee: IPWireless, Inc., San Bruno, CA (US)

(21) Appl. No.: 11/701,712

(22) Filed: Feb. 2, 2007

(51) Int. Cl. H04Q 7/20

(52) U.S. Cl. 455/458

(57) ABSTRACT

Paging group identifiers are associated with groups of user equipment (UEs) in a hierarchical manner. A controller, such as a scheduler in an enhanced Node B, may address the groups of UEs using group identifiers over control channels. The controller may select a group identifier for a group of UEs from higher or lower levels of the hierarchy, depending upon the number of UEs to be paged and/or the number of available control channels over which paging resources are dynamically allocated to the UEs. UEs within the addressed groups monitor the corresponding paging channels for paging messages.

### BACKGROUND OF THE INVENTION

In a wireless communications system, e.g., the Universal Mobile Telecommunications System (UMTS), paging may be used to convey information to user equipment (UE) in idle or connected modes. (In idle mode, the mobile terminal has no connection to the radio access network of base stations, but it is connected to the core network.) The network may page the UEs to establish a signaling connection, trigger a cell update procedure, or initiate reading of updated system information, for example.

A system based on shared channel operation should guarantee radio resource sharing among various transport/physical channels. As a shared channel, the paging channel (PCH) should thus be mapped to the physical resources that are dynamically shared by other channels. To enable dynamic radio resource sharing, the physical resources used for the PCH may be signaled to the UEs using out-of-band control signaling. Such resources include time/frequency allocations, and modulation and coding information needed to decode the paging channel.

In a conventional paging procedure, two signals are used to convey the paging message. The first paging signal is used to indicate whether a paging message is being transmitted to a particular UE or group of UEs. The second paging signal carries the paging message(s) for the particular UE or group of UEs. The second paging signal is transmitted following the first paging signal at a fixed time offset from the first paging signal.

The UE uses Discontinuous Reception (DRX) in sleep/idle mode to reduce power consumption. When DRX is used, the mobile terminal monitors the first paging signal only at one paging occasion per DRX cycle. The core network usually knows when the mobile terminal will be monitoring the first paging signal within the DRX cycle. Thus, if the network intends to page a particular mobile terminal, it sends the first paging signal at the time when the mobile terminal will be monitoring the paging channel. If the mobile terminal is not paged in the first paging signal, it goes back to the sleep/idle mode. Otherwise, the mobile terminal reads the second paging signal.

FIG. 1 illustrates channel allocation for a paging procedure in a system based on shared channel operation. The control channel 100 is an L1/L2 control signaling channel, which may be the same as the control signaling channel used for shared data channel operation. Each PCH 102 is accompanied by a control channel. The paging ID 104 is a paging group ID (referred to as “PGID” herein), with the same form as the existing C-RNTI (cell radio network temporary identifier). Thus, a group of (one or more) IDs from the C-RNTI ID space may be reserved for paging.

Each UE is assigned a PGID by the network for use in the paging procedure. The UEs first monitor the L1/L2 control channel. The L1/L2 control channel header indicates the address of the intended UE or group of UEs. The control channel payload 106 indicates the resources dynamically allocated for PCH. If the paging ID sent by the network matches a UE's paging ID, the UE reads the paging channel PCH. The paging channel carries the paging messages (which include the TMSIs of the UEs being paged and the corresponding cause values) intended for a number of UEs.

One issue concerns how many paging groups should be allocated to achieve efficient paging. Two scenarios are addressed below.

If one or only a few paging groups are supported (option 1)

requires one or a few PGIDs

requires one or a few (L1/L2) control signaling channels

If a larger number of UEs may be paged in one DRX instance, the message size of the PCH must increase. Note that paging is performed over the entire Tracking Area, which may consist of a number of cell sites. Thus, a larger number of UEs may be paged in one instance. Paging a larger number of UEs in this scenario raises the following issues:
difficulty in optimizing the system when a large message size is delivered to the cell edge users.
because paging signals intended for a number of UEs are concatenated in one large message, the UE receiving the PCH needs to decode the complete paging message from the paging channel (PCH) to determine whether it is being paged. This increases UE complexity and processing.
if one group indicates a relatively large number of UEs, all the UEs belonging to the group need to wake up and read the PCH if that group ID is indicated in the control channel. This reduces UE power saving.

On the other hand,

if a large number of paging groups are supported (option 2)

requires a large number of PGIDs

requires a large number of (L1/L2) control signaling channels (one for each PGID). However, the number of L1/L2 control channels is limited in a system. Under these constraints, the system cannot page all groups of UEs in one paging instance. Paging blocking to delay the paging of some UEs will increase call connection delay.

a group contains a smaller number of UEs compared to one paging group in which a set number of UEs belong to only one paging group.

because PCH only carries paging messages for a smaller number of UEs, the message size on PCH is small Thus, UE complexity and processing is reduced.

as a smaller number of UEs belong to a group, a smaller number of UEs need to read PCH, resulting in improved power saving.

If only one (or very few) UEs in each group need to be paged, the required number of L1/L2 control channels equals the number of groups. This is very radio inefficient.

Option 1 increases the complexity and processing of the UE, and reduces the power saving of the UE. Management of transmission power on PCH may also be difficult in case a very large number of UEs in a group must be paged.

Option 2 has two main issues: first the limited number of L1/L2 control channels. Second, if the number of UEs paged from each group is very small, this results in inefficient radio transmission.

Both option 1 and 2 fail to provide an efficient paging procedure with reasonable UE power saving, reduced UE complexity, and reduced paging delay.

One scheduling technique, known as persistence scheduling, is described in detail in R2-070335, “Scheduling for LTE”, Motorola, 3GPP TSG-RAN WG2#56-bis, Sorrento, Italy, 15-19 January, 2007. FIG. 2 illustrates the format of the L1/L2 control channel 200 in this scheme. The formatting of the L1/L2 control channel is designed to accommodate information for a number of groups, and thus it includes multiple resource grants for different paging channels PCH.

The paging ID 202 addresses a Group of Paging Groups (GPG). The “indication of group ID” field 204 indicates which groups are being paged. In this example, bit mapping 206 is used to indicate which groups are being paged. The bit pattern is pre-configured and known to the paging groups. In the example shown, groups 1, 4 and 6 are paged. Corresponding resource grants for PCHs are included in the payload 208. According to the example, three different PCH channels are used for three groups.

In the example, there are seven paging groups. The seven groups of UEs monitor three paging channels. The assignment of UEs to paging channels is fixed in the system, and generally only changed by actions such as a network broadcast. For the seven paging groups, only one PGID is allocated for all seven groups. Note that individual paging groups are not assigned a paging group ID. Thus, the system needs to reserve only one ID from the C-RNTI ID space for paging.

All the UEs belonging to the GPG read the address field of the paging control channel. If the bit mapped field for a UE's group ID is set to 1, the UE reads the payload of the paging control channel and also the corresponding paging channel.

Disadvantages of this solution are
requires a special format of L1/L2 control channel. Increases the system/UE complexity.
because a large amount of information is carried over L1/L2, this scheme requires a high transmission power to reach cell edge users.
inefficient resource usage if only one paging group within a GPG is to be paged. Even though, only one location of the bit mapping is set to one, the entire “indication of group ID” field needs to be transmitted.
If only a few users are to be paged (i.e., paging load is low) it is beneficial to transmit paging signals within one PCH. However, if these users belong to different paging groups (e.g., four groups), the payload must include four occurrences of “resource for PCH,” even though the same information is repeated because the UE to PCH resource field assignment is fixed. This results in inefficient radio resource usage.

It is desired to develop a paging scheme that overcomes the inefficiency and inflexibility inherent in conventional schemes, and that enables greater UE power saving, reduced UE complexity, and reduced paging delay.

### BRIEF SUMMARY OF THE INVENTION

According to embodiments of the present invention, a paging group identifier (“P-RNTI’) assignment is performed in a hierarchical manner to ensure scheduler flexibility and efficient radio usage. Each UE is assigned a number of P-RNTIs, where each P-RNTI corresponds to one P-RNTI from each level of the hierarchy. Compared to the conventional shared channel operation where the UE is assigned only one paging group identifier, in embodiments of the present invention the UE checks the ID on the control channel to determine whether any of its assigned P-RNTIs are signaled on the control channel. If so, the UE reads the paging channel for a paging message.

Groups of UEs may be paged by associating at least two hierarchically related group identifiers with a first group of UEs, and addressing, over a control channel, the UEs to be paged within the first group using one of the at least two group identifiers within a paging cycle. In some embodiments, a first first-level group identifier identifies the first group of UEs, a second first-level group identifier identifies a second group of UEs, and a second-level group identifier identifies a superset of the first and second groups of UEs. Note that “first-level” in the claims does not necessarily denote the lowest level in the hierarchy.

The group identifier for paging may be selected from either the first first-level group identifier or the second-level group identifier, where the first first-level group identifier may correspond to the lowest level of the hierarchy. The group identifier for addressing may be selected based upon the number of UEs to be paged and/or the number of available control channels.

### BRIEF DESCRIPTION OF THE DRAWINGS

FIG. 1 illustrates a paging channel and a corresponding control channel which may be used by embodiments of the invention.

FIG. 2 illustrates the format of an L1/L2 control channel according to a persistence scheduling scheme of the prior art.

FIG. 3 illustrates a wireless communication system in which embodiments of the invention may be implemented.

FIG. 4 illustrates a hierarchical organization of paging group identifiers for idle state UEs according to embodiments of the invention.

FIGS. 5A-5C together provide a table illustrating the results of a grouping algorithm according to embodiments of the invention.

FIG. 6 illustrates the partial organization of paging group identifiers according to an algorithm implemented by embodiments of the invention.

FIG. 7 illustrates a hierarchical organization of paging group identifiers for connected state UEs according to embodiments of the invention.

FIG. 8 illustrates a typical computing system that may be employed to implement processing functionality in embodiments of the invention.

### DETAILED DESCRIPTION OF THE INVENTION

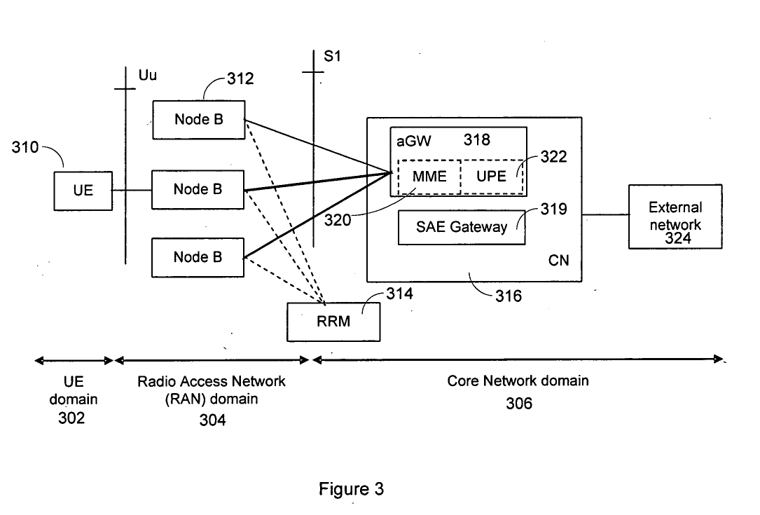

FIG. 3 illustrates an example of a cellular communication system according to embodiments of the invention. The network includes a user equipment (UE) domain 302, a radio access network (RAN) domain, and a core network domain 306. The UE domain includes user equipment 310 that communicate with at least one base station (e.g., Node B) 312 in the RAN domain via a wireless interface. The RAN domain may also include a network controller (e.g., radio network controller) (not shown), such as that used in UMTS systems. Alternatively, such functionality may be distributed between the Node Bs 3012 and an access gateway (aGW) 318 or other controller in the core network. The figure also illustrates an optional radio resource manager (RRM) 314. The RRM 314 may perform functions otherwise performed by the Node Bs or aGW in some embodiments.

The core network (CN) 316 includes, in this example, an aGW 318 and a system architecture evolution (SAE) gateway 319. The aGW 318 may include a Mobility Management Entity (MME) 320 and a User Plane Entity (UPE) 322. The MME manages and stores the UE context, such as UE/user identities, UE mobility state, and user security parameters for the idle state. The MME checks for authorization whether the UE may camp on the TA (Tracking Area) or on the Public Land Mobile Network (PLMN). It also authenticates the user.

For idle state UEs, the UPE 322 initiates paging when downlink data arrives for the UE at the core network, and terminates the downlink data path when the core network has no more data to send. The UPE manages and stores UE contexts, e.g., parameters of the IP bearer service or network internal routing information. The SAE Gateway 319 provides gateway access between 3GPP and non-3GPP networks. The core network is coupled to an external network 324.

Further background details may be found in the 3GPP technical specifications, such as TS 36.300 23.246 v0.4.0(2007-01) “3rd Generation Partnership Project; Technical Specification Group Radio Access Network, Evolved Universal Terrestrial Radio Access Network (E-UTRAN), Overall description, Stage 2 (Release 8),” and “TR 23.882 v1.6.1(2006-11) “3rd Generation Partnership Project; Technical Specification Group services and system aspects, 3GPP system architecture evolution, report on technical options and conclusions (Release 7)” published by the 3GPP Support Office, 650 Route des Lucioles—Sophia Antipolis, Valbonne—FRANCE, which are incorporated by reference herein.

### Hierarchical Organization of P-RNTIs: Idle State UEs

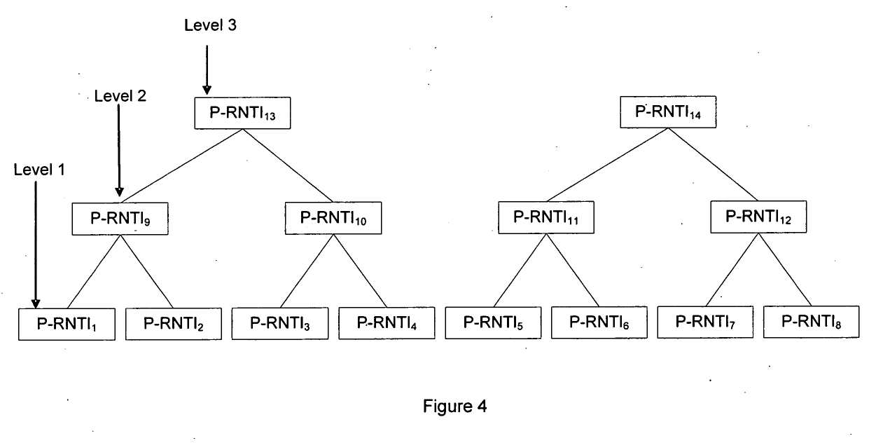

FIG. 4 illustrates an example of hierarchical organization of UE group identifiers (denoted herein as “P-RNTIs”) for idle state UEs according to embodiments of the invention. In this example, the group IDs are organized in a binary tree. UEs camped in the system are divided into N (e.g., eight) paging groups (PG). This division may be based on the DRX cycle of the UEs, the International Mobile Subscriber Identity (IMSI) or Temporary Mobile Subscriber Identity (TMSI) of the UEs, or other information, such as UE velocity.

The N paging groups are further grouped into M (e.g., four) groups of paging groups (GPG). M is less than N. The grouping may be based upon the history of UE activity, the history of incoming calls for the UEs, or other parameters, or may be based on a mathematical function such as binary tree hierarchical organization. The M groups may be further grouped into K (e.g., two) groups of GPG.

A number of C-RNTIs, equivalent to the sum of paging groups in each level in the hierarchy should be reserved for the paging procedure. Three levels of hierarchy are used in the example of FIG. 4. According to the example N=8, M=4 and K=2. Thus, 14 (8+4+2) C-RNTIs should be reserved for use as P-RNTIs.

Each UE belongs to one of the paging groups (PG)(i.e., level 1). The UE is assigned a level 1 P-RNTI (corresponding to the UE's paging group), a level 2 P-RNTI (corresponding to the level 1 P-RNTI) and a level 3 P-RNTI (corresponding to the level 2 P-RNTI). For example, UEs belong to paging group 1 are assigned P-RNTI₁, P-RNTI₉ and P-RNTI₁₃.

A controller, such as an enhanced node B (eNB) or aGW in an LTE system, or a node B, radio network controller, or core network element in a 3G system, may use any of these P-RNTIs to signal the UE on the level 1/level 2 (L1/L2) downlink control channel. The UE may check for all its assigned P-RNTIs to determine whether one of its paging groups is being paged. For example, after decoding the received signal (L1/L2 control channel), the UE belonging to paging group 1 performs an L1/L2 control channel paging ID check with P-RNTI₁. If that fails, then it checks whether P-RNTI₉ is being addressed by the controller. If that fails, then it checks whether P-RNTI₁₃ is being addressed.

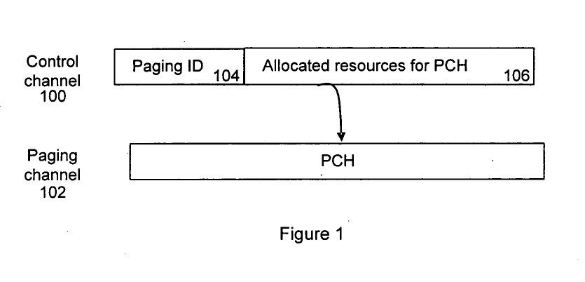

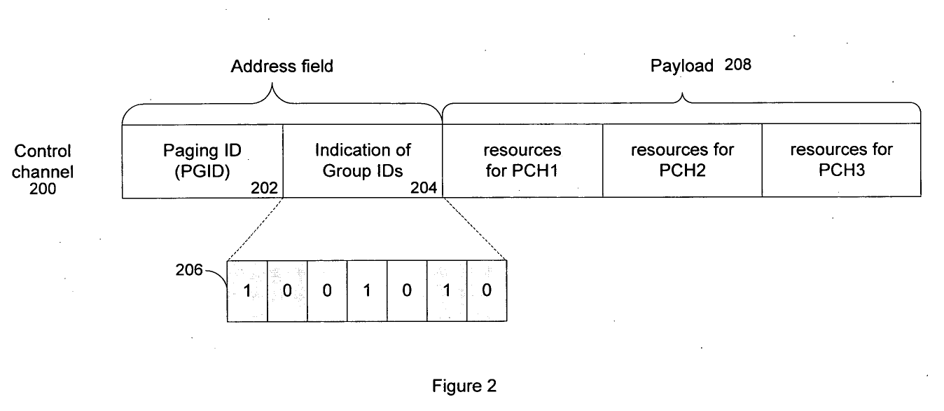

Referring back to FIG. 1, embodiments of the invention support the use of the conventional L1/L2 control channel. FIG. 1 illustrates a PCH and its accompanying L1/L2 control channel. The control channel includes an ID field 104 and a payload 106 including a pointer to the allocated resources for the data channel. The user (group) ID field 104 may be indicated via CRC masking or explicitly indicated as shown in the figure.

The paging channel 102 includes IDs for each UE within the group being paged (e.g., the TMSIs of the UEs) and the corresponding cause values. (The cause values indicate the reason for paging, e.g., establishing a voice connection.) Thus, the PCH corresponding to a particular level of P-RNTI group identifier includes all the UE IDs corresponding to the group identifiers at the levels below. For example, referring to FIG. 4, the PCH corresponding to P-RNTI9 at level 2 includes all the UE IDs (that are being paged) from the PCH for both P-RNTI1 and P-RNTI2 from level 1.

If the UE finds that any of its assigned P-RNTIs are signaled in the L1/L2 control channel, it reads the PCH for a paging signal. This hierarchical P-RNTI allocation provides flexibility for the controller (e.g., scheduler in the eNB), resulting in efficient radio usage, greater UE power saving, reduced UE complexity, and reduced paging delay as explained below.

As a particular example of a grouping algorithm, assume the number of first level groups is N, second level groups is M, and third level groups is K The grouping may be performed based upon the UEs' initial IDs. The UE initial ID may, for example, be either the IMSI (International Mobile Subscriber Identity) or TMSI (Temporary Mobile Subscriber Identity) of the UE. The grouping algorithm may be executed in a controller in the network, such as in an eNB (e.g., in a scheduler), in a UE, or in the core network.

The UE is allocated the first level group based on the UEs initial ID. The group index, q (0, . . . , N−1), is identified as

$$q = ⌊ \frac{UE\_initial \_ID}{A} ⌋ \text{mod} N$$

where A is an integer constant.

The P-RNTIs allocated for level 1 groups may be marked as P-RNTI_{q}.

The second level of grouping is performed based on the first level group index, q. The second level group index, p (0, . . . ,M−1), is calculated as

$$p = ⌊ \frac{q}{B} ⌋ \text{mod} M$$

Where B is an integer constant.

The P-RNTIs allocated for level 2 groups may be marked as P-RNTI_{(N+p)}.

The third level of grouping is performed based on the second level group index, p. The third level group index, r(1, . . . ,K−1), is calculated as

$$r = ⌊ \frac{p}{C} ⌋ \text{mod} K$$

Where C is an integer constant.

The P-RNTIs allocated for level 3 groups may be marked as P-RNTI_{(N+M+r)}.

The following is a further example based on IMSI. An IMSI is usually fifteen digits long.

Assume 250 UEs have IMSIs ranging from 004410000800000 to 004410000800249.
N=50, M=20, K=4;
A=5; B=2; C=1.

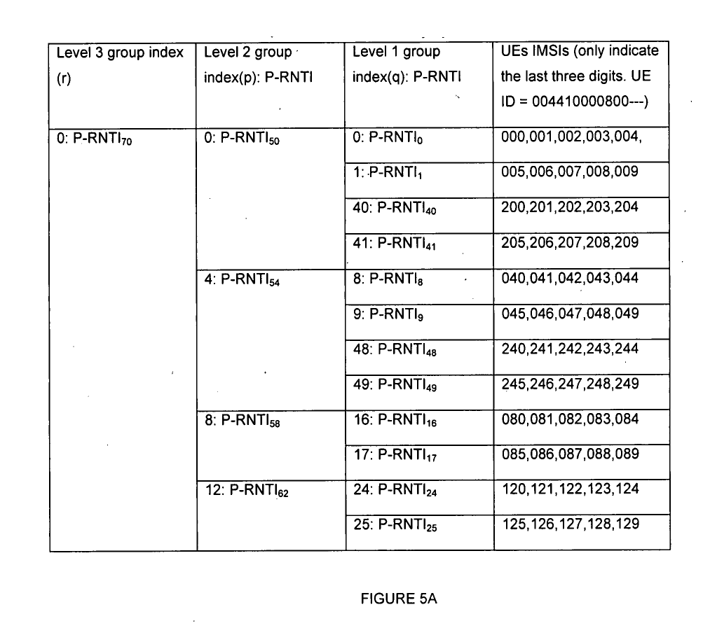

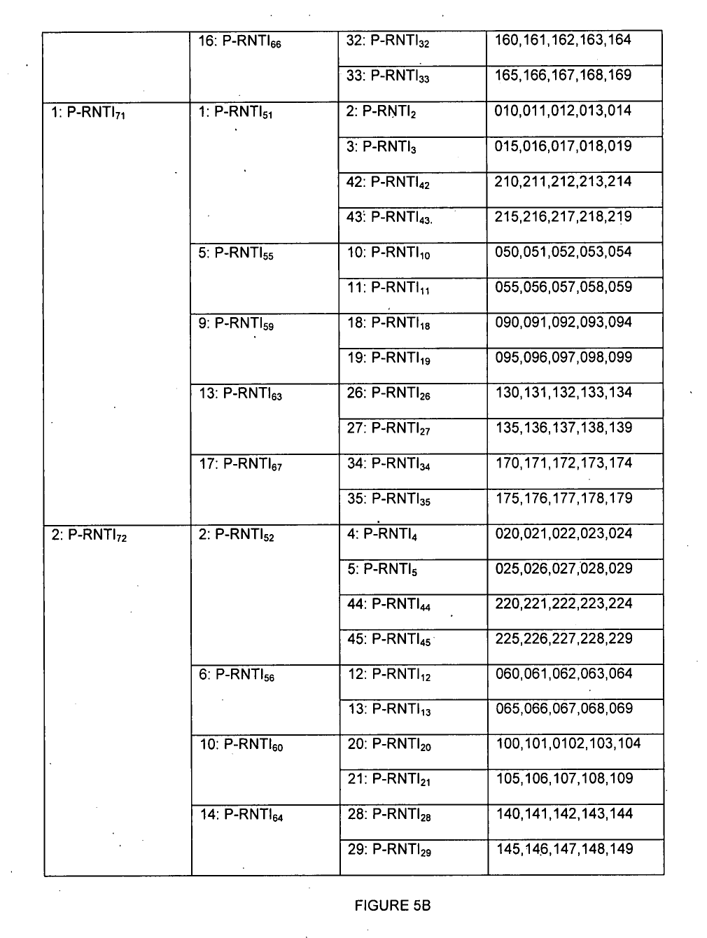

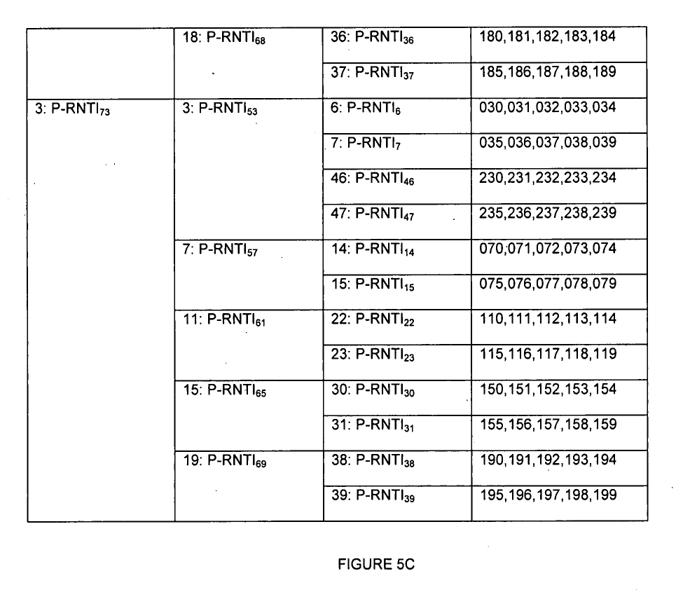

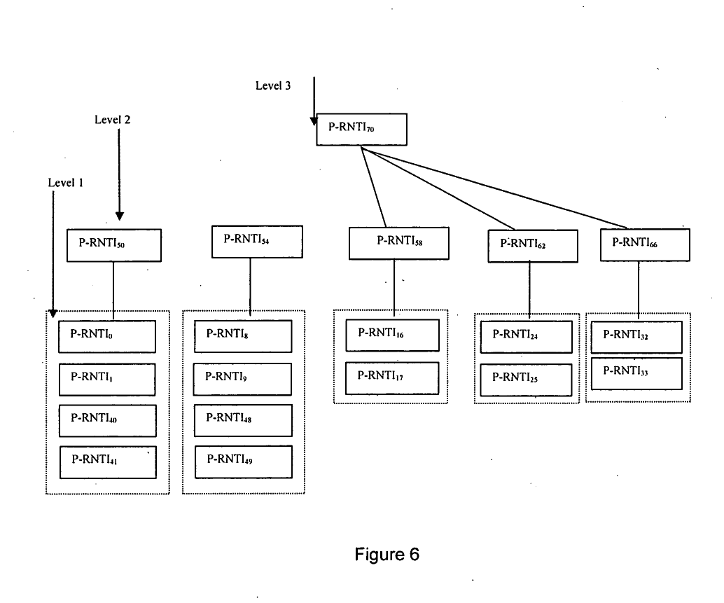

See the the table collectively shown in FIGS. 5A-5C for the resulting groupings. In addition, FIG. 6 illustrates a portion of the resulting grouping for the first branch.

### Paging for Idle State UEs

Referring back to the example of FIG. 4, the UEs are grouped into eight paging groups based on their TMSIs. The P-RNTIs are hierarchically allocated based on a binary tree. The UEs belonging to paging group 1 are assigned P-RNTI₁, P-RNTI₉ and P-RNTI₁₃. The UEs belonging to paging group 4 are assigned P-RNTI₄, P-RNTI₁₀ and P-RNTI₁₃. The UEs belonging to paging group 5 are assigned P-RNTI₅, P-RNTI₁₁ and P-RNTI₁₄.

In embodiments of the invention, the limiting factors that determine the number of P-RNTIs (and associated control channels) to be used for paging are the capacity (message size) of the paging channel and the number of available control channels. For example, if the number of UEs to be paged in one paging cycle would result in paging signals exceeding the capacity of one paging channel, then the system may employ at least two P-RNTIs (and associated control channels), e.g., two low-level P-RNTIs instead of one high-level P-RNTI. On the other hand, if the number of available control channels is limited, then the system may employ a limited number of P-RNTIs, e.g., one high-level P-RNTI (and accompanying control channel) instead of two lower level P-RNTIs (and their two accompanying control channels). The system may use a combination of both factors to determine the appropriate number of P-RNTIs. For example, the appropriate number of P-RNTIs to be used during one paging cycle may be bounded by the capacity of the paging channel and the number of available control channels.

The following are some possible paging scenarios.

Scenario 1: only UEs belong to paging group 1 need to be paged.

The eNB uses P-RNTI₁ to address the UEs. This only requires one L1/L2 control channel and one PCH channel.

Scenario 2: only UEs belong to paging group 1 and 2 need to be paged. The total number of UEs to be paged is relatively low (i.e., can be accommodated in one PCH).

Because paging for the total number of UEs can be accommodated in one PCH, the eNB may use P-RNTI₉ to address the UEs. This requires only one L1/L2 control channel and one PCH channel.

Scenario 3: only UEs belong to paging group 1 and 2 need to be paged. The total number of UEs to be paged is large (i.e., greater than the capacity of the PCH to signal within one paging cycle).

Because the paging signals for the large number of UEs cannot be accommodated in one PCH, the eNB may use P-RNTI₁ and P-RNTI₂ to address the UEs. This requires two L1/L2 control channels and two PCH channels.
ensures low UE complexity because the message size on PCH is controlled by the eNB.

Scenario 4: only UEs belong to paging group 1, 2 and 3 need to be paged. The total number of UEs to be paged is low (i.e., can be accommodated in one PCH).

The eNB may use P-RNTI₁₃ to address the UEs. This requires only one L1/L2 control channel and one PCH channel.

Scenario 5: only UEs belonging to paging group 1, 2 and 3 need to be paged. The total number of UEs to be paged is large, including a small number of group 1 and 2 UEs and a large number of group 3 UEs.

Because the total number of UEs to be paged is large, the paging signal intended for the UEs cannot be accommodated in one PCH. Thus, the eNB may use P-RNTI₉ and P-RNTI₃ to address the UEs. This requires two L1/L2 control channels and two PCH channels.

The advantages of such a hierarchical paging organization are:

use of L1/L2 control channel as in normal operation reduces system/UE complexity

this method gives full control to the scheduler at the eNB over allocation of L1/L2 control channels, the size of the message on PCH, and the transmission power on the channels carrying paging information depending on the cell load, available cell resources, available L1/L2 control channels, the total number of UEs to be paged in one instance, and eNB maximum transmission power.

required number of L1/L2 control channels is controlled/selected by the scheduler at eNB

message size on PCH is controlled/formatted by the scheduler at the eNB

low UE complexity on processing the message due to the control of message size by the eNB

eNB (scheduler) controls how many UEs should read PCH, resulting in improved UE power saving

### Hierarchical Organization and Paging for Connected State UEs

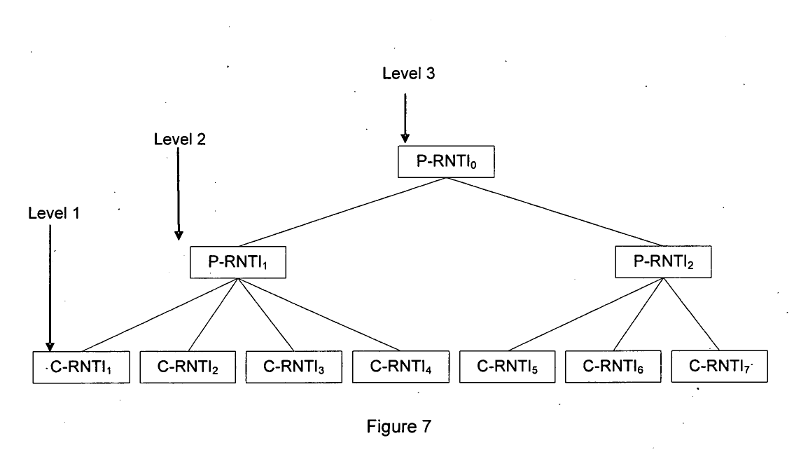

A UE in the connected state is associated with a C-RNTI, as is known in the art. Consequently, the controller may signal an individual UE using its C-RNTI. If N UEs need to be signaled, such a system would require N L1/L2 control channels. However, if, according to embodiments of the invention, the UEs are also assigned level 2 and level 3 P-RNTIs, then a group of UEs may be signalled using one L1/L2 control channel. In that case, group IDs may be allocated as shown in FIG. 7.

Level 1 corresponds to the UE ID, level 2 group ID, and level 3 the GPG ID. The controller (e.g., in the eNB) can address the UE either with the UE's own ID or the assigned group IDs. The UE monitors the control channel for its own ID and also for assigned group ID(s). After decoding the L1/L2 control channel, the UE checks for its own ID first. If that fails, then it checks for its assigned level 2 group ID. If that fails, the UE checks for its level 3 group ID (GPG ID).

One difference between the paging technique of embodiments of the invention for idle UEs vs. connected UEs is that, for connected UEs, the DL-SCH (downlink shared channel) may used instead of PCH (paging channel) to deliver the paging message.

According to embodiments of the invention, a connected state UE may function as follows:

Scenario 1: only one UE (e.g., UE1) needs to be paged.

The eNB uses the UE's C-RNTI, C-RNTI₁, to address the UE. This only requires one L1/L2 control channel. The paging message is delivered over the DL-SCH indicated on the L1/L2 control channel.

Scenario 2: UE1, UE2 and UE3 are to be paged. All these UEs belong to one group.

The eNB uses P-RNTI₁ to address the UEs. This requires only one L1/L2 control channel and paging message is delivered over the DL-SCH indicated on the L1/L2 control channel.

### Signaling

### Idle State UEs:

The UE can be informed of the set of P-RNTIs to which the UE belongs via a number of means, including:

RRC signaling at RRC connection release. When the UE transitions to idle state from a connected state, the controller (e.g., in the eNB) may signal to the UE the P-RNTIs assigned to the UE.

The P-RNTI allocation pattern or algorithm may be maintained within the UE itself. For example, the UE may include a table that stores the P-RNTI-UE association based upon the applicable standard. Alternatively, the UE may include software or firmware that computes its P-RNTI assignments based on a grouping algorithm maintained in the UE.

The P-RNTI allocation pattern/algorithm can be broadcast in the cell using broadcast channels. For example, the controller (e.g., in the eNB) may broadcast the P-RNTI assignments to the UEs in the corresponding cell.

### Connected State UE:

The P-RNTIs may be allocated to the UE when it enters the. DRX cycle. In an LTE system, for example, the eNB delivers DRX information to the UE during the DRX cycle. Similarly, a controller (e.g., eNB) may deliver P-RNTI values in the same message, which the UE monitors in addition to the UE's C-RNTI while in the DRX. The message may be delivered using either RRC or MAC signaling.

Alternatively, the P-RNTIs may be allocated to the UE at the initial access (connection establishment).

The foregoing illustrates that embodiments of the invention overcome the inefficiencies and inflexibility of conventional paging schemes. Embodiments of the invention eliminate the requirement of fields for a fixed number of individual paging indicators within the paging control channel (like the prior art paging indicator channel (PICH) approach). Embodiments of the invention instead employ the paging group ID (P-RNTI) in the address field of the paging control channel, which can be flexibly/dynamically selected based on the number of UEs to be paged and/or the number of available control channels.

For example, the prior art persistence scheduling scheme follows the traditional PICH and PCH based paging procedure (as in UMTS) with the primary difference being dynamic resource allocation for PCH. In traditional PICH and PCH based paging, the resources allocated for PCH are fixed, and signaled to the UE via System Information broadcast in the cell over the paging control channel.

In that scheme, paging can be considered to require three steps.

Step 1: UE reads the address field of the paging control channel, including the “indication of Group IDs” field.

Step 2: if the bit mapped for the group to which the UE belongs is set to 1, then the UE reads the payload of the paging control channel to obtain the PCH resource allocation.

Step 3: UE reads the corresponding PCH for the paging signal.

In contrast, according to embodiments of the invention, the paging procedure involves two steps:

Step 1: the UE reads the paging control channel.

Step 2: the UE reads the PCH indicated by the paging control channel.

Furthermore, according to the invention, the P-RNTIS are organized in a hierarchical manner. This allocation guarantees the flexibility of the scheduler in allocating the paging control channel, resources for the paging channel, and transmission power on paging channels, while taking into account the available resources of the system (system resources, control channel resources, transmission power) and the paging load. This scheme also reduces UE complexity and improves UE power saving.

While the invention has been described in terms of particular embodiments and illustrative figures, those of ordinary skill in the art will recognize that the invention is not limited to the embodiments or figures described. Although embodiments of the present invention are described, in some instances, using UMTS terminology, those skilled in the art will recognize that such terms are also used in a generic sense herein, and that the present invention is not limited to such systems.

Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

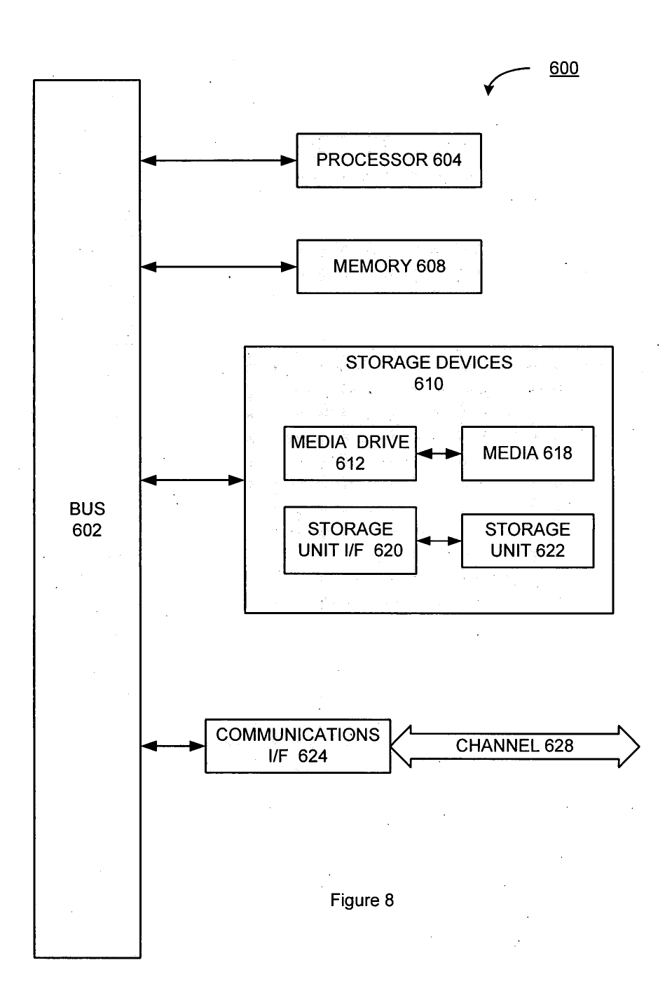

FIG. 8 illustrates a typical computing system 600 that may be employed to implement processing functionality in embodiments of the invention. Computing systems of this type may be used in the eNB (in particular, the scheduler of the eNB), core network elements, such as the aGW, and the UEs, for example. Those skilled in the relevant art will also recognize how to implement the invention using other computer systems or architectures. Computing system 600 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 600 can include one or more processors, such as a processor 604. Processor 604 can be implemented using a general or special purpose processing engine such as, for example, a microprocessor, microcontroller or other control logic. In this example, processor 604 is connected to a bus 602 or other communications medium.

Computing system 600 can also include a main memory 608, such as random access memory (RAM) or other dynamic memory, for storing information and instructions to be executed by processor 604. Main memory 608 also may be used for storing temporary variables or other intermediate information during execution of instructions to be executed by processor 604. Computing system 600 may likewise include a read only memory (“ROM”) or other static storage device coupled to bus 602 for storing static information and instructions for processor 604.

The computing system 600 may also include information storage system 610, which may include, for example, a media drive 612 and a removable storage interface 620. The media drive 612 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 618, may include, for example, a hard disk, floppy disk, magnetic tape, optical disk, CD or DVD, or other fixed or removable medium that is read by and written to by media drive 614. As these examples illustrate, the storage media 618 may include a computer-readable storage medium having stored therein particular computer software or data.

In alternative embodiments, information storage system 610 may include other similar components for allowing computer programs or other instructions or data to be loaded into computing system 600. Such components may include, for example, a removable storage unit 622 and an interface 620, such as a program cartridge and cartridge interface, a removable memory (for example, a flash memory or other removable memory module) and memory slot, and other removable storage units 622 and interfaces 620 that allow software and data to be transferred from the removable storage unit 618 to computing system 600.

Computing system 600 can also include a communications interface 624. Communications interface 624 can be used to allow software and data to be transferred between computing system 600 and external devices. Examples of communications interface 624 can include a modem, a network interface (such as an Ethernet or other NIC card), a communications port (such as for example, a USB port), a PCMCIA slot and card, etc. Software and data transferred via communications interface 624 are in the form of signals which can be electronic, electromagnetic, optical or other signals capable of being received by communications interface 624. These signals are provided to communications interface 624 via a channel 628. This channel 628 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 608, storage device 618, or storage unit 622. These and other forms of computer-readable media may store one or more instructions for use by processor 604, to cause the processor to perform specified operations. Such instructions, generally referred to as “computer program code” (which may be grouped in the form of computer programs or other groupings), when executed, enable the computing system 600 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 600 using, for example, removable storage drive 614, drive 612 or communications interface 624. The control logic (in this example, software instructions or computer program code), when executed by the processor 604, causes the processor 604 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for paging groups of user equipment (UEs), the method comprising:
associating at least two group identifiers with a first group of UEs, wherein the at least two group identifiers are hierarchically related; and
addressing the UEs to be paged within the first group using only one of the at least two group identifiers

2. The method of claim 1, wherein a first first-level group identifier identifies the first group of UEs, a second first-level group identifier identifies a second group of UEs, and a second-level group identifier identifies a superset of the first and second groups of UEs.

3. The method of claim 2, further comprising selecting the group identifier for addressing from either the first first-level group identifier or the second-level group identifier.

4. The method of claim 3, wherein the first first-level group identifier corresponds to the lowest level of the hierarchy.

5. The method of claim 1, further comprising selecting the group identifier for addressing based upon the number of UEs to be paged.

6. The method of claim 5, further comprising selecting the group identifier for addressing based upon the number of UEs to be paged and the number of available control channels.

7. The method of claim 2, further comprising:
if the first and second first-level groups of UEs are to be paged:
selecting the first and second first-level group identifiers for addressing the first and second groups of UEs, respectively, if the number of UEs to be paged exceeds a threshold; and
selecting the second-level group identifier for addressing the first and second groups of UEs if the number of UEs to be paged falls below a threshold.

8. The method of claim 2, further comprising:
if the first and second first-level groups of UEs are to be paged:
selecting the first and second first-level group identifiers for addressing the first and second groups of UEs, respectively, if the number of available control channels exceeds a threshold; and
selecting the second-level group identifier for addressing the first and second groups of UEs if the number of available control channels falls below a threshold.

9. The method of claims 7 or 8, wherein addressing comprises addressing the UEs to be paged with the selected group identifier over a corresponding control channel.

10. The method of claim 1, wherein a UE within the first group of UEs is in the connected state and at least one of the group identifiers is a C-RNTI.

11. The method of claim 1, further comprising signaling to each UE within the first group of UEs the association of the at least two group identifiers with each UE within the first group of UEs.

12. A controller for paging user equipment (UEs) in a wireless communications network, the controller comprising:
logic for associating at least two group identifiers with a first group of UEs, wherein the at least two group identifiers are hierarchically related; and
logic for addressing the UEs to be paged within the first group using only one of the at least two group identifiers

13. The controller of claim 12, wherein a first first-level group identifier identifies the first group of UEs, a second first-level group identifier identifies a second group of UEs, and a second-level group identifier identifies a superset of the first and second groups of UEs.

14. The controller of claim 13, further comprising logic for selecting the group identifier for paging from either the first first-level group identifier or the second-level group identifier.

15. The controller of claim 14, wherein the first first-level group identifier corresponds to the lowest level of the hierarchy.

16. The controller of claim 12, further comprising logic for selecting the group identifier for addressing based upon the number of UEs to be paged.

17. The controller of claim 16, further comprising logic for selecting the group identifier for addressing based upon the number of UEs to be paged and the number of available control channels.

18. The controller of claim 13, further comprising logic for:
if the first and second first-level groups of UEs are to be paged:
selecting the first and second first-level group identifiers for addressing the first and second groups of UEs, respectively, if the number of UEs to be paged exceeds a threshold; and
selecting the second-level group identifier for addressing the first and second groups of UEs if the number of UEs to be paged falls below a threshold.

19. The controller of claim 13, further comprising logic for:
if the first and second first-level groups of UEs are to be paged:
selecting the first and second first-level group identifiers for addressing the first and second groups of UEs, respectively, if the number of available control channels exceeds a threshold; and
selecting the second-level group identifier for addressing the first and second groups of UEs if the number of available control channels falls below a threshold.

20. The controller of claims 18 or 19, wherein the logic for addressing is operable to address the UEs to be paged with the selected group identifier over a corresponding control channel.

21. The controller of claim 12, wherein a UE within the first group of UEs is in the connected state and at least one of the group identifiers is a C-RNTI.

22. The controller of claim 12, further comprising logic for signaling to each UE within the first group of UEs the association of the at least two group identifiers with each UE within the first group of UEs.

23. A method in a user equipment (UE) for paging operation in a wireless communications network, wherein the UE belongs to a group of UEs, the method comprising:
selecting a group identifier from at least two group identifiers, wherein the at least two group identifiers are associated with the group of UEs, and the at least two group identifiers are hierarchically related;
detecting the selected group identifier over a control channel; and
monitoring a paging channel for a paging message if the selected group identifier is detected.

24. The method of claim 23, wherein selecting comprises:
selecting a lowest-level group identifier for detection, and
if the lowest-level group identifier is not detected, selecting a higher-level group identifier for detection.

25. The method of claim 23, further comprising associating the at least two group identifiers with the UE.

26. The method of claim 25, wherein associating comprises associating the at least two group identifiers with the UE using an association, stored within the UE, of the group identifiers with the UE.

27. The method of claim 25, wherein associating comprises associating the at least two group identifiers with the UE by computing, within the UE, the association of the group identifiers with the UE.

28. A user equipment (UE), wherein the UE belongs to a group of UEs, the UE comprising:
logic for selecting a group identifier from at least two group identifiers, wherein the at least two group identifiers are associated with the group of UEs, and the at least two group identifiers are hierarchically related;
logic for detecting the selected group identifier over a control channel; and
logic for monitoring a paging channel for a paging message if the selected group identifier is detected.

29. The UE of claim 28, wherein the logic for selecting is operable to
select a lowest-level group identifier for detection, and
if the lowest-level group identifier is not detected, select a higher-level group identifier for detection.

30. The UE of claim 28, further comprising logic for associating the at least two group identifiers with the UE.

31. The UE of claim 30, wherein the logic for associating comprises a stored association of the group identifiers with the UE.

32. The UE of claim 30, wherein the logic for associating comprises logic for computing the association of the group identifiers with the UE.

33. A computer-readable medium, for use in a user equipment (UE), comprising program code for paging operation in a wireless communications network, wherein the UE belongs to a group of UEs, the program code for causing performance of the method comprising:
selecting a group identifier from at least two group identifiers, wherein the at least two group identifiers are associated with the group of UEs, and the at least two group identifiers are hierarchically related;
detecting the selected group identifier over a control channel; and
monitoring a paging channel for a paging message if the selected group identifier is detected.

34. The computer-readable medium of claim 33, wherein selecting comprises:
selecting a lowest-level group identifier for detection, and
if the lowest-level group identifier is not detected, selecting a higher-level group identifier for detection.

35. The computer-readable medium of claim 33, further comprising program code for associating the at least two group identifiers with the UE.

36. The computer-readable medium of claim 35, wherein associating comprises associating the at least two group identifiers with the UE using an association, stored within the UE, of the group identifiers with the UE.

37. The computer-readable medium of claim 35, wherein associating comprises associating the at least two group identifiers with the UE by computing, within the UE, the association of the group identifiers with the UE.

38. A computer-readable medium comprising program code for paging groups of user equipment (UEs) in a wireless communications network, the program code for causing the method comprising:
associating at least two group identifiers with a first group of UEs, wherein the at least two group identifiers are hierarchically related; and
addressing the UEs within the first group to be paged using only one of the at least two group identifiers

39. The computer-readable medium of claim 38, wherein a first first-level group identifier identifies the first group of UEs, a second first-level group identifier identifies a second group of UEs, and a second-level group identifier identifies a superset of the first and second groups of UEs.

40. The computer-readable medium of claim 39, further comprising program code for selecting the group identifier for addressing from either the first first-level group identifier or the second-level group identifier.

41. The computer-readable medium of claim 40, wherein the first first-level group identifier corresponds to the lowest level of the hierarchy.

42. The computer-readable medium of claim 38, further comprising program code for selecting the group identifier for addressing based upon the number of UEs to be paged.

43. The computer-readable medium of claim 42, further comprising program code for selecting the group identifier for addressing based upon the number of UEs to be paged and the number of available control channels.

44. The computer-readable medium of claim 39, further comprising program code for:
if the first and second first-level groups of UEs are to be paged:
selecting the first and second first-level group identifiers for addressing the first and second groups of UEs, respectively, if the number of UEs to be paged exceeds a threshold; and
selecting the second-level group identifier for addressing the first and second groups of UEs if the number of UEs to be paged falls below a threshold.

45. The computer-readable medium of claim 39, further comprising program code for:
if the first and second first-level groups of UEs are to be paged:
selecting the first and second first-level group identifiers for addressing the first and second groups of UEs, respectively, if the number of available control channels exceeds a threshold; and
selecting the second-level group identifier for addressing the first and second groups of UEs if the number of available control channels falls below a threshold.

46. The computer-readable medium of claims 44 or 45, wherein addressing comprises addressing the UEs to be paged with the selected group identifier over a corresponding control channel.

47. The computer-readable medium of claim 38, wherein a UE within the first group of UEs is in the connected state and at least one of the group identifiers is a C-RNTI.

48. The computer-readable medium of claim 38, further comprising program code for signaling to each UE within the first group of UEs the association of the at least two group identifiers with each UE within the first group of UEs.
